(19) United States
(12) Patent Application Publication
(10) Pub. No.: US 2025/0114778 A1
(43) Pub. Date: Apr. 10, 2025

(54) CHAMBER EXPLOSION SYNTHESIS OF TIO2-TIC HYBRIDS

(71) Applicants: Kansas State University Research Foundation, Manhattan, KS (US); Hydrograph Clean Power Inc., Vancouver (CA)

(72) Inventors: Placidus B. Amama, Manhattan, KS (US); Christopher M. Sorensen, Manhattan, KS (US); Ahmed Al Mayyahi, Manhattan, KS (US); Shusil Sigdel, Manhattan, KS (US)

(21) Appl. No.: 18/907,946

(22) Filed: Oct. 7, 2024

Related U.S. Application Data
(60) Provisional application No. 63/588,574, filed on Oct. 6, 2023.

(51) Int. Cl. B01J 37/14; B01D 53/86; B01J 21/06; B01J 27/22; B01J 35/30; B01J 35/39; B01J 35/40; B01J 35/45; B01J 37/08; B01J 37/34

(52) U.S. Cl. CPC B01J 37/14; B01D 53/8628; B01J 21/063; B01J 27/22; B01J 35/39; B01J 35/397; B01J 35/40; B01J 35/45; B01J 37/08; B01J 37/347; B01D 2255/20707; B01D 2255/802; B01D 2255/9202

(57) ABSTRACT

A one-step process to synthesize narrow band gap TiO₂—TiC core-shell particles is described. A mixture of a fuel source, particularly a hydrocarbon, and a titanium precursor is detonated with a source of oxygen in a constant volume reaction vessel to produce TiO₂—TiC core-shell particles. This process can synthesize TiO₂—TiC core-shell structures with tailored morphology, size, phase, absorption behavior, and other hybrid morphologies with different properties depending on the Ti/C ratio used in the feed.

### CROSS-REFERENCE TO RELATED APPLICATION

This application claims the benefit of U.S. Provisional Patent Application No. 63/588,574, filed Oct. 6, 2023, which is incorporated by reference herein in its entirety.

### STATEMENT REGARDING FEDERALLY SPONSORED RESEARCH AND DEVELOPMENT

This invention was made with government support under Contract No. 1653527 awarded by the National Science Foundation. The government has certain rights in the invention.

### BACKGROUND OF THE INVENTION

TiO₂ absorption can be extended to visible light regions using metal and non-metal doping, surface reduction, and coupling with narrow band gap semiconductors. However, the trade-off relationship between light absorption of TiO₂ and its catalytic activity is a significant challenge. Doping or reduction is based on creating localized energy states above or below the valance band or conduction band of TiO₂. These states allow the intra-band transition of electrons under visible light and subsequently enable visible light absorption. However, the concentration of these localized energy states in conventional photocatalysts is low due to the non-uniform interaction between TiO₂ and the dopants. Also, the same localized energy states serve as recombination centers for charge carriers, particularly those formed due to TiO₂ reduction, boosting electron-hole recombination. While coupling TiO₂ with other narrow band gap semiconductors can enable visible light activity without compromising electron-hole separation, this approach may reduce photocatalyst stability and undermine its practical application.

TiO₂-nanocarbon core-shell structures have recently emerged as promising visible light active photocatalysts. In these unique structures, the nanocarbon (the core) shares a few carbon atoms with TiO₂ (the shell) to create localized energy states in its band, enabling electron transition under visible light. At the same time, the nanocarbon may serve as an electron (or hole) reservoir to accept the electrons (or holes) from TiO₂, hindering charge carrier consumption induced by localized energy states. More importantly, the well-tailored boundary between TiO₂ and the nanocarbon at the interface in the core-shell structure maximizes the number of localized energy states in the TiO₂ band and boosts visible light absorption. It is also noted that previous studies showed that core-shell structure possesses higher stability compared to other binary structures.

Among various cores that a TiO₂ shell can sandwich, TiC is an earth-abundant early transition metal featured by its high electrical conductivity and superior stability under harsh conditions. Nevertheless, TiO₂—TiC core-shell structure is rarely used in photocatalysis, probably due to the difficulties associated with its synthesis. TiO₂—TiC core-hole structure is typically produced by thermal nucleation of the TiO₂ shell on commercial TiC. However, the synthesis of TiC itself is complicated; TiC is commercially synthesized by “the carbothermal reduction” of TiO₂. The carbothermal reduction is based on a reaction between TiO₂ and a carbonaceous source (i.e., carbon black) at high temperatures for 10-24 hours. Therefore, the overall synthesis of TiO₂—TiC core-shell structure is time-consuming and requires complex tools typified by the presence of at least three reactors to synthesize TiO₂, carbonaceous materials, and TiC. This, in turn, reduces production efficiency and increases synthesis costs. It is also important to mention that controlling the size and morphology of the TiO₂—TiC core-shell structure by the conventional approach is challenging, creating another obstacle in front of the expansion of this unique structure.

TiO₂—TiC is also a promising material in energy conversion (electrocatalyst in fuel cells) while TiO₂—TiC-graphene is a promising material as an electrode in Li-ion batteries (energy storage). TiO₂—TiC exhibits high stability during catalysis due to the lattice match in the interface. Owing to the exceptional properties of TiO₂—TiC nanostructures, they are one of the leading electrocatalysts and energy storage electrode materials. Due to the versatility of TiO₂—TiC core-shell structure, it is not only highly desired in photocatalysis but also energy storage and conversion; an alternative synthesis approach for this structure is urgently needed.

One or more embodiments of the present invention are directed toward a one-step, ultrafast, scalable, economical, environmentally friendly, and novel process to synthesize narrow band gap TiO₂—TiC core-shell structure. A mixture of hydrocarbon (e.g., C₇H₈) and titanium precursor (e.g., TiCl₄) is detonated with oxygen (e.g., molecular O₂) in a multi-liter chamber to produce around seven grams of TiO₂—TiC core-shell structure per second. This process can synthesize TiO₂—TiC core-shell structures with tailored morphology, size, phase, absorption behavior, and other hybrid morphologies with different properties depending on the Ti/C ratio used in the feed.

In one application, the TiO₂—TiC hybrid materials may be used as catalysts, and in particular, as photocatalysts for oxidation of NOx gases to nitrates.

### SUMMARY OF THE INVENTION

According to one embodiment of the present invention, a method is provided for producing a TiO₂—TiC hybrid material from a gaseous reaction mixture comprising a mixture of a fuel and a titanium precursor material. The reaction mixture is placed within a reaction vessel and then energy is supplied to the reaction mixture, preferably in the form of a spark or other means of ignition, and an exothermic reaction is initiated thereby forming the TiO₂—TiC hybrid material.

According to another embodiment, a chamber detonation process for large-scale synthesis of high-quality, TiO₂-graphene-TiC hybrid materials from liquid precursors is provided. The liquid precursors, such as toluene and titanium tetrachloride, are placed in a reaction chamber which is filled with an oxidizing agent, such as oxygen. The chamber is heated to evaporate the liquids. Then the gaseous mixture is ignited with an electric spark. The resulting exothermic reaction yields an aerosol of multi-layer, turbostratic graphene-TiO₂—TiC and graphene-TiO₂ composites with atomic ratios that can be tuned by adjusting the ratios of the precursors. This tunable composition in turn allows tuning of the optical and catalytic properties of the product. The product demonstrates strong photocatalytic behavior under visible light by both reducing the band gap of TiO₂ and having the TiC act as an electron reservoir to retard the recombination of electron-hole pairs. Advantages associated with the chamber detonation process are: minimal energy needs, short synthesis time, environmentally benign, economic viability, scalability and tunable product selectivity.

In one or more embodiments, the present invention enables the production of TiO₂—TiC hybrids in a single step, thereby reducing the complexity and time required for manufacturing compared to traditional methods that involve multiple steps.

In one or more embodiments, the present invention renders the production of scalable quantities of TiO₂—TiC hybrids possible. This means that large volumes of hybrids can be generated, addressing the demand for commercial applications in areas such as catalysis and energy storage, in contrast to traditional technologies with limited scalability.

In one or more embodiments, the present invention allows for the tailoring of TiO₂—TiC hybrids with various morphologies (core-shell and layered), sizes, and optical properties. This versatility enables tailoring of the properties of the hybrids for specific applications, in contrast to other technologies with limited control over size, morphology, and optical properties.

In one or more embodiments, the process for producing the hybrids is catalyst-free, thereby eliminating the need for additional materials and simplifying the manufacturing process.

In one or more embodiments, processes according to the present invention generate no toxic waste during the production of the TiO₂—TiC hybrids, thus offering a significant advantage over other methods that may produce harmful by-products or waste. The method is exothermic, hence, requires minimal energy usage.

In one or more embodiments, no post-purification step is required. Thus, such embodiments comprise a single-step process for producing TiO₂—TiC hybrids. In particular embodiments, a calcination step can be performed to remove graphene from the as-synthesized TiO₂—TiC-graphene to yield pure TiO₂—TiC.

### BRIEF DESCRIPTION OF THE DRAWINGS

FIG. 1 is a schematic depiction of an exemplary apparatus for producing the TiO₂—TiC hybrid materials;

FIG. 2 provides SEM images of TiO₂—TiC hybrids from explosion synthesis: (a) TiO₂—TiC-0.16, (b) TiO₂—TiC-0.38, (c) TiO₂—TiC-0.73, and (d) TiO₂—TiC-1;

FIG. 3 depicts: (a) a TEM image of the core-shell structure; (b) a high-resolution TEM image, (c) an SAED pattern; (d) a dark field TEM image and the corresponding EDS mapping; and (e) another TEM image and the EDS scan line along the arrow in the image;

FIG. 4 depicts: (a) NO conversion and (b) DeNOx index and NOx storage selectivity of TiO₂—TiC-0.73 under different humidity levels (high and low humidity), (c) NO conversion and (d) DeNOx index and NOx storage selectivity of P25 and TiO₂—TiC-0.73 under high humidity; and

FIG. 5 depicts charts of NOx oxidation over TiO₂—TiC hybrids and commercial TiO₂ (P25) under blue light exposure and 50% relative humidity with (a) illustrating NO conversion and (b) illustrating DeNOx index.

### DETAILED DESCRIPTION OF THE PREFERRED EMBODIMENT

In one or more embodiments, a gaseous reaction mixture comprising a fuel and a titanium precursor undergoes a rapid, exothermic reaction in the presence of an oxidizing agent, preferably molecular oxygen, to yield a TiO₂—TiC hybrid material.

Preferably, the fuel comprises a material that is typically a liquid at 25° C. In further embodiments, the fuel comprises a C2 to C12 hydrocarbon compound. In still further embodiments, the hydrocarbon compound comprises an aromatic hydrocarbon compound such as xylene, toluene, benzene, or a mixture thereof.

In one or more embodiments, the titanium precursor material has a boiling point of from about 80° C. to about 300° C., or from about 100° C. to about 250° C., or from about 125° C. to about 200° C., thus enabling the liquid precursor to be volatilized under relatively mild heating conditions. In particular embodiments, the titanium precursor comprises a halogenated titanium compound (e.g., a titanium halide) and/or a titanium alkoxide compound. In certain embodiments, the titanium precursor comprises titanium tetrachloride and/or titanium isopropoxide.

In one or more embodiments, the exothermic reaction comprises a detonation reaction. As used herein, “detonation” is distinguished from mere “deflagration” or “burning” of the carbon-containing material. Detonation typically involves a supersonic exothermic front that accelerates through a medium that eventually drives a shock front propagating directly in front of it. Deflagration is typically described as subsonic combustion propagating through heat transfer. Detonation reactions are also generally characterized by the production of higher temperatures in the reactants and reaction products. The exothermic reaction can be initiated via any conventional means such as an electrical spark generator.

In one or more embodiments, the exothermic reaction achieves temperatures within the reaction vessel of at least 2000K, at least 2250K, or at least 2500K. Preferably, the temperature within the reaction vessel during the exothermic reaction is from about 2000K to about 4000K, about 2500K to about 3500K, or about 2750K to about 3000K, thus permitting the formation of graphene along with the TiO₂—TiC hybrid material.

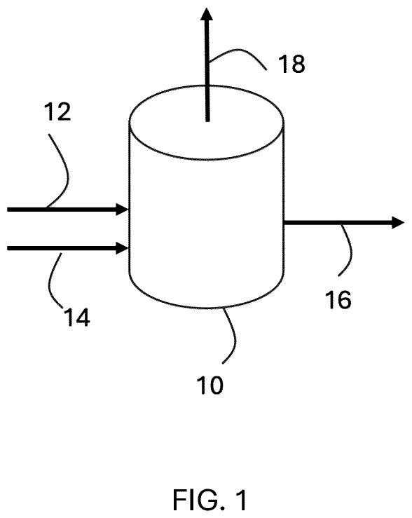

In particular embodiments, as depicted in FIG. 1, the exothermic reaction takes place within a constant volume reaction vessel 10. The use of a constant volume reaction vessel is preferred as the exothermic reaction produces no work. Thus, all energy released by the exothermic reaction is used to raise the temperature within the reaction vessel leading to the formation of the graphene and TiO₂—TiC hybrid material.

Fuel from a fuel source 12 and the titanium precursor form a titanium precursor source 14 are fed to the reaction vessel 10. The fuel 12 and titanium precursor 14 can be fed directly to the reaction vessel 10 separately, or they can be combined upstream of the reaction vessel and introduced as a combined stream. In addition, the fuel 12 and titanium precursor 14 can be introduced into the reaction vessel 10 as an aerosol in which droplets of the liquid fuel 12 and liquid titanium precursor 14 are suspended within an oxygen-containing gas. Alternatively, the liquid fuel 12 and liquid titanium precursor 14 can be heated and vaporized and introduced into the reaction vessel 10 in gaseous form. A source of oxygen, such as molecular oxygen, air, or a NOx compound, can be separately introduced into the reaction vessel 10, or it can be included within one of streams 12 or 14.

The physical characteristics of the TiO₂—TiC hybrid material formed via the exothermic reaction can be controlled by controlling the ratio of the titanium precursor material to fuel present within the reaction mixture. In one or more embodiments, the molar ratio of the titanium precursor to the fuel in the reaction mixture is from about 0.05:1 to 2:1, from about 0.075:1 to 1.5:1, from about 0.1:1 to 1.25:1, or from about 0.16:1 to 1:1.

The reaction mixture within the reaction vessel 10 is ignited, such as with a spark-generating device. Once initiated, the reaction proceeds exothermically to produce reaction products 16 and a waste stream 18 comprising unreacted fuel or titanium precursor and/or gaseous byproducts. As mentioned above, the exothermic reaction may be conducted at temperatures sufficiently high in which graphene is formed. Thus, the reaction product 16 formed not only comprises the TiO₂—TiC hybrid material, but quantities of graphene as well. In certain embodiments, it is desirable to remove the graphene from the TiO₂—TiC hybrid material. Therefore, methods according to the present invention may further comprise a step of calcining the TiO₂—TiC hybrid material to remove graphene therefrom. In particular embodiments, the calcination step occurs at a temperature of at least 400° C., at least 450° C., or at least 500° C.

In one or more embodiments, the TiO₂—TiC hybrid material comprises a plurality of core-shell particles. Particularly, the core of the core-shell particles comprises TiC and the shell comprises TiO₂. In certain embodiments, the hybrid material comprises a plurality of core-shell particles having particle sizes of 1 μm or less, 500 nm or less, or 300 nm or less. In alternate embodiments, the hybrid material comprises a plurality of core-shell particles having particle sizes of from about 50 nm to about 1 μm, from about 100 nm to about 500 nm, or from about 200 nm to about 300 nm.

In one or more embodiments, the TiO₂—TiC hybrid material exhibits a band gap of less than 3.2 eV. In particular embodiments, the hybrid material exhibits a band gap of from about 2.93 to about 3.06 eV.

### EXAMPLES

The following examples set forth preferred compositions and methods according to one or more embodiments of the present invention. It is understood, however, that these examples are provided by way of illustration and nothing therein should be taken as a limitation upon the overall scope of the invention.

In these examples a mixture of hydrocarbon (such as toluene (C₇H₈ (l), xylene (l), or benzene (l)) and titanium precursor (such as titanium tetrachloride (TiCl₄ (l)) or titanium isopropoxide (C₁₂H₂₈O₄Ti (l)) are exploded in a batch reactor (see, FIG. 1) via an electric spark in the presence of oxygen (O₂) to form TiO₂—TiC hybrids. In this example, various concentrations of C₇H₈ and TiCl₄ are used, while maintaining a constant O₂ concentration. This process produces large amounts of TiO₂—TiC hybrids per second, 5 grams per explosion. XRD analysis confirmed the formation of TiO₂—TiC hybrids, evident by the presence of peaks associated with TiC and TiO₂. The samples obtained are labeled as TiO₂—TiC-(ratio of moles of TiCl₄ fed into the reactor to moles of C₇H₈ fed into the reactor).

### Experimental

To fabricate the hybrid structures, a mixture of C₇H₈ (l) and TiCl₄ (l) with different ratios was injected into the reactor, which is preheated to 80° C. The different ratios, as shown in Equations 1-4, were 0.16, 0.38, 0.73, and 1.0. The mixture is detonated in the presence of oxygen by a spark (10,000 V) generated from an industrial step-up transformer. Various concentrations of C₇H₈ and TiCl₄ are used, while O₂ concentration was maintained at 0.36 mole, as shown in equations (1-4). TiO₂—TiC core-shell was obtained for a Ti/C feed mole ratio of 0.73. The produced structures are denoted as TiO₂—TiC-x, where x=mole of C₇H₈/mole of TiCl₄. The resulting products were calcined at 550° C. and characterized using a plethora of material characterization techniques, including X-ray diffraction (XRD), X-ray photoelectron spectroscopy (XPS), scanning electron microscopy (SEM), energy dispersive spectroscopy (EDS), transmission electron microscopy (TEM), Raman spectroscopy, and UV-Visible spectroscopy.

$$0.027 ( mole ) {TiCl}_{4} + 0.1 \; 60 ( mole ) {C}_{7} {H}_{8} + 0.36 ( mole ) {O}_{2} = {TiO}_{2} - TiC - 0.16 \qquad ( 1 )$$

$$0.054 ( mole ) {TiCl}_{4} + 0.14 ( mole ) {C}_{7} {H}_{8} + 0.36 ( mole ) {O}_{2} = {TiO}_{2} - TiC - 0.38 \qquad ( 2 )$$

$$0.082 ( mole ) {TiCl}_{4} + 0.112 ( mole ) {C}_{7} {H}_{8} + 0.36 ( mole ) {O}_{2} = {TiO}_{2} - TiC - 0.73 \qquad ( 3 )$$

$$0.095 ( mole ) {TiCl}_{4} + 0.095 ( mole ) {C}_{7} {H}_{8} + 0.36 ( mole ) {O}_{2} = {TiO}_{2} - TiC - 1 \qquad ( 4 )$$

To evaluate the photocatalytic activity, the NOx oxidation experiment was performed in a continuous-flow reactor built following ISO standards. Two gas cylinders were connected to the reactor containing 100 ppm NO in N₂ and breathing air. Mass flow controllers monitored the flow rate of gases to the reactor. The humidity on the inlet gas mixture was measured by a sensor-push HT1 humidity sensor and used to adjust for high and low humidity levels. The reactor was made from steel with a quartz glass window to allow light penetration to the surface of the photocatalyst. The emission wavelength ranges of light used were UV-A (370-405 nm), violet (395-425 nm), royal (410-445 nm), blue (425-465 nm), and green (455-515). A chemiluminescent 42C Low Source analyzer (Thermo Fisher Scientific) was used to measure NO and NO₂ concentrations. A substrate coated with a photocatalyst was loaded into the reactor, and NOx was introduced to the reactor for adequate adsorption of gaseous molecules on the photocatalyst surface. The light was turned on, and the reaction was continued at 1.0 ppm NOx and a total airflow of 1000 sccm at 10 or 50% relative humidity (RH). The light was turned off after the experiment, and the NOx was allowed to re-equilibrate. Average NO, NO₂, and NOx concentrations were determined by averaging all data obtained during the oxidation reaction.

### Results and Discussion

XRD analysis of the detonation structures established the presence of TiC and rutile TiO₂, evident by the peaks at 27.4°, 44°, 54.4°, 56.6°, 62.7°, 64°, and 69° attributed to (110), (210), (211), (220), (002), (310), and (301) facets of rutile, respectively, while peaks at 36.1° and 41.3° are associated with (111) and (200) planes of TiC, respectively. The presence of anatase TiO₂ is only observed at C₇H₈/TiCl₄<1, evident by the presence of peaks at 25°, 37.9° and 48.2° ascribed to (101), (004), and (200) planes of anatase TiO₂. The results suggest that the ratio of TiCl₄ to C₇H₈ is a crucial factor in regulating TiO₂ phases in the structure. In addition, SEM images of synthesized structures and the corresponding size histograms indicate that this ratio is also essential to control the size and morphology of the samples. XPS analysis of the samples does not detect the presence of peaks associated with TiC, suggesting that the surface of the samples mainly comprised TiO₂, likely due to the formation of a core-shell structure.

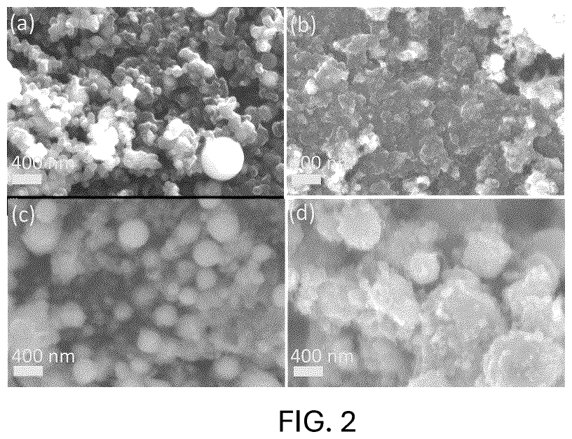

The process offers precise control over the size and geometry of the produced hybrids. The SEM images in FIG. 2 reveal the possibility of forming TiC—TiO₂ with spherical-like structures, as in the case of TiO₂—TiC-0.16 and TiO₂—TiC-0.73, and sheet-like structures, as in the case of TiO₂—TiC-0.38 and TiO₂—TiC-1 (see FIG. 2). Consequently, this process empowers the customization of TiO₂—TiC hybrids, allowing for the tailoring of their geometry and structure to match the specific requirements of the intended application.

Compared with P25, the samples exhibited noticeable absorption in the visible light region. Based on the modified Tauc plot approach, the band gaps of TiO₂ in TiO₂—TiC-0.16, TiO₂—TiC-0.38, TiO₂—TiC-0.73 and TiO₂—TiC-1 are estimated to be 3.00, 3.14, 2.93 and 3.06 eV, respectively, which are smaller than that of commercial TiO₂ (P25, 3.25 eV). Since the band gap of TiO₂—TiC-0.73 is the lowest among the other hybrids, this is the structure of focus hereafter.

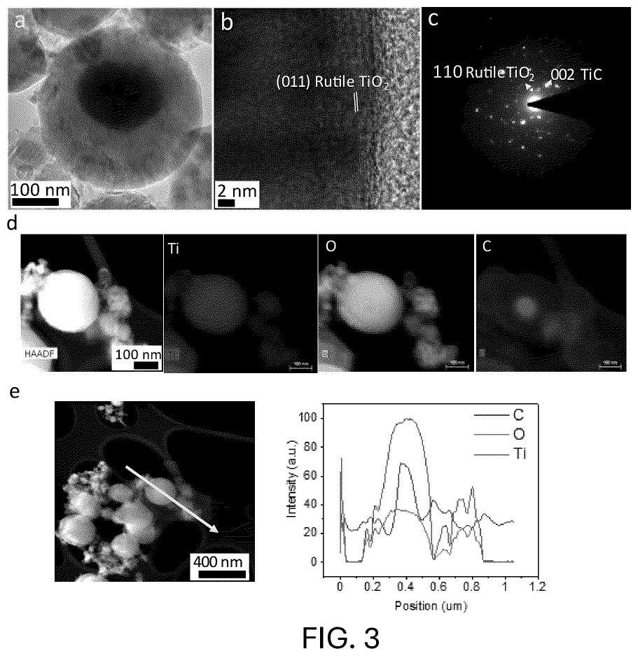

TEM image (a) of FIG. 3 of TiO₂—TiC-0.73 confirmed the formation of core-shell structure, and the high-resolution TEM image of (b) of FIG. 3 taken on the shell asserts that the shell is made of TiO₂, evident by the presence of dominant lattice fringe corresponding to (011) rutile TiO₂. EDS mapping (d) of FIG. 3 and EDS line scanning (e) of FIG. 3 detect the presence of a high amount of carbon in the core, suggesting that the TiC is located in the core. While the peaks in the XPS spectrum of TiO₂—TiC-0.73 are mainly attributed to TiO₂, as mentioned earlier, peaks associated with TiC appear upon etching the sample by argon beam, as observed in XPS depth profile analysis. This further indicates that the TiC is located in the core. Therefore, TEM, EDS, and XPS data confirm the formation of a TiC core sandwiched by a TiO₂ shell by the detonation process.

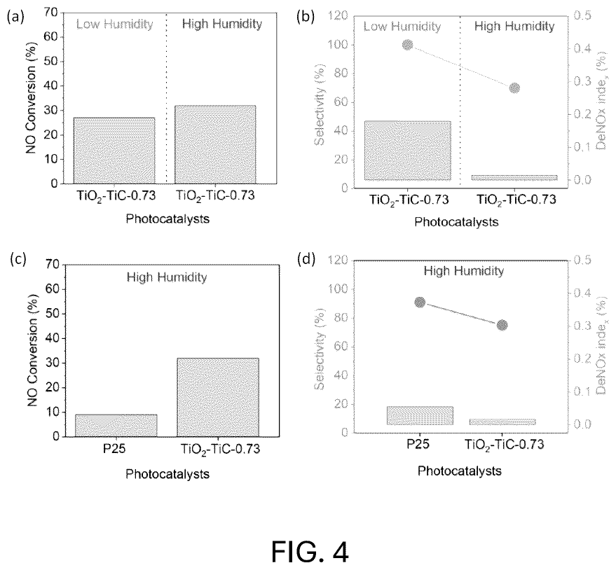

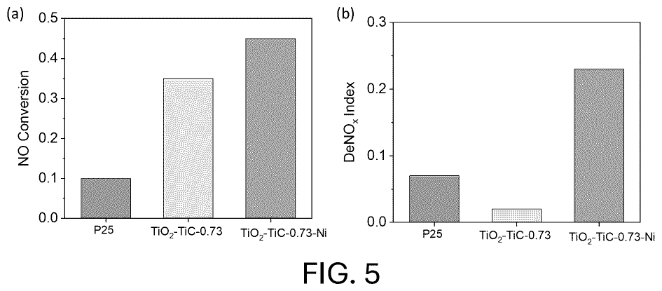

TiO₂—TiC-0.73 is used in NOx oxidation in a continuous flow reactor. TiO₂—TiC-0.73 performance under visible light represented by NO conversion, NOx storage selectivity, and DeNOx index are shown in (a) and (b) of FIG. 4. TiO₂—TiC-0.73 shows noticeable NO conversion with a purification effect under low and high humidity levels, confirming the potential of utilizing this structure in visible light-driven photocatalysis. The NO conversion of TiO₂—TiC-0.72 (ca. 30%) is three times higher than that of commercial TiO₂ (ca. 10%), as depicted in (c) of FIG. 5, further confirming the activity of TiO₂—TiC-0.73 under visible light. It is noted that under visible light and high humidity, commercial TiO₂ did not generate NO₂, evident by its purification effect ((d) of FIG. 4). This observation contradicts the characteristic performance of P25, which is featured by its toxification effect. Therefore, considering the relatively large band gap of P25 (3.25 eV), it is reasonable to assume that the 10% conversion achieved under visible is due to non-photocatalytic routes. Interestingly, TiO₂—TiC-0.73 showed higher NO conversion than P25 under UV light. Both P25 and TiO₂—TiC-0.72 have a more or less identical surface area, 47.89 m²/g for TiO₂—TiC-0.73 and 58.96 m²/g for P25. Therefore, the difference in the photocatalytic activity of P25 and TiO₂—TiC-0.73 under UV light is attributed to the difference in the concentration of charge carriers on their surfaces, with the likelihood of the presence of higher concentration of carriers on TiO₂—TiC-0.73.

The process produced photocatalyst hybrids that can be utilized in NOx oxidation (abatement) under conditions relevant to practical applications, including visible light illumination and humidity levels representative of most urban areas. As depicted in FIG. 5, TiO₂—TiC-0.73 showed 35% NO conversion under blue light while demonstrating a positive DeNOx index, indicating its purification effect. Upon further modification of TiO₂—TiC-0.73 with nickel (Ni), the NO conversion further increased to 45%, and the catalyst demonstrated an exceptional purification effect, evidenced by its high positive DeNOx index of 0.23. It is important to note that the commercial TiO₂ (P25), the gold standard in photocatalysis, demonstrated a lower conversion of 10%, confirming the superior activity of TiO₂—TiC hybrids and their potential as efficient photocatalysts to combat NOₓ pollution.

In TiO₂—TiC-0.73, TiC is expected to accept the electrons from TiO₂, leaving holes in the shell, which are then tarped by H₂O adsorbed on the surface to form hydroxyl radical, enabling the hole-mediated NOx oxidation. It is noted that TiC is characterized by strong localized surface plasmon resonance (LSPR) absorption in visible light; hence, it can form hot electrons. These energetic electrons may get ejected from TiC to TiO₂ and then trapped by the oxygen adsorbed at the surface to form superoxide radicals, enabling electron-mediated NOx oxidation. The impact of this expected spatial transfer of photoexcited electrons from TiO₂ to TiC and hot electrons from TiC to TiO₂ may favor electron-hole separation.

In summary, a facile, economical, and scalable approach to synthesize a narrow band gap TiO₂—TiC core-shell structure has been demonstrated. This approach is based on detonating a mixture of TiCl₄ and C₇H₈ in the milli-liter reactor to produce 7 grams of the core-shell structure per second. TiO₂—TiC core-shell structure absorbs longer wavelengths than commercial TiO₂ (P25) and performs effective NOx oxidation under visible light.

The process also enables control of the optical absorption behavior of the TiO₂—TiC hybrids. The UV-Vis absorption spectra of the samples reveal that the absorption of TiO₂—TiC can be tuned depending on the concentration of TiCl₄ and C₇H₈ used in the explosion. Tauc plots showed that the hybrids possess band gaps ranging from 2.93 to 3.06 eV. It is noteworthy that the band gaps of explosion hybrids are smaller than that of commercial TiO₂ (P25, 3.2 eV); therefore, they are capable of absorbing longer wavelengths than P25, making them suitable for the efficient harvesting of renewable energy from the sun.

The process enables the formation of a TiO₂—TiC core-shell structure. For example, TiO₂—TiC-0.73 is a core-shell structure, represented by a TiO₂ shell surrounding a TiC core as depicted by TEM images and corresponding X-ray energy dispersive spectra (EDS) and selected area electron diffraction (SAED) analysis (FIG. 3). The TiO₂—TiC core-shell structure is highly desired in various applications, including catalysis and energy storage.

We claim:

1. A method of producing a TiO₂—TiC hybrid material comprising:
forming a gaseous reaction mixture of a fuel and a titanium precursor material within a reaction vessel;
supplying energy to the reaction mixture in the presence of oxygen and initiating an exothermic reaction and forming the TiO₂—TiC hybrid material.

2. The method of claim 1, wherein the fuel comprises a C2 to C12 hydrocarbon compound.

3. The method of claim 2, wherein the hydrocarbon compound comprises an aromatic hydrocarbon compound.

4. The method of claim 4, wherein the aromatic hydrocarbon compound comprises xylene, toluene, and/or benzene.

5. The method of claim 1, wherein the titanium precursor material has a boiling point of from about 80° C. to about 300° C.

6. The method of claim 5, wherein the titanium precursor comprises a halogenated titanium compound and/or a titanium alkoxide compound.

7. The method of claim 6, wherein the titanium precursor comprises titanium tetrachloride and/or titanium isopropoxide.

8. The method of claim 1, wherein the exothermic reaction comprises a detonation reaction.

9. The method of claim 1, wherein the step of supplying energy to the reaction mixture comprises supplying an electric spark to the reaction mixture.

10. The method of claim 1, wherein the molar ratio of the titanium precursor to the fuel in the reaction mixture is from about 0.05:1 to 2:1.

11. The method of claim 1, wherein the TiO₂—TiC hybrid material further comprises graphene.

12. The method of claim 11, further comprising the step of calcining the TiO₂—TiC hybrid material to remove graphene therefrom.

13. The method of claim 12, wherein the calcining step occurs at a temperature of at least 400° C.

14. The method of claim 1, wherein the TiO₂ of the hybrid material comprises rutile and/or anatase.

15. The method of claim 1, wherein the TiO₂—TiC hybrid material comprises a plurality of core-shell particles having particle sizes of 1 μm or less.

16. The method of claim 1, wherein the TiO₂—TiC hybrid material comprises a plurality of core-shell particles having particle sizes of from about 50 nm to about 1 μm.

17. The method of claim 1, wherein the TiO₂—TiC hybrid material comprises a plurality of core-shell particles, wherein the core comprises TiC and the shell comprises TiO₂.

18. A TiO₂—TiC hybrid material formed by the method of claim 1.

19. The hybrid material of claim 18, wherein the hybrid material exhibits a band gap of less than 3.2 eV.

20. The hybrid material of claim 19, wherein the hybrid material exhibits a band gap of from about 2.93 to 3.06 eV.
